(19) United States
(12) Patent Application Publication
(10) Pub. No.: US 2016/0233020 A1
(43) Pub. Date: Aug. 11, 2016

(54) TRANSFORMER

(71) Applicant: DELTA ELECTRONICS, INC., Taoyuan City (TW)

(72) Inventors: Hsi-Kuo Chung, Taoyuan City (TW); Yu-Liang Hung, Taoyuan City (TW)

(21) Appl. No.: 14/704,565

(22) Filed: May 5, 2015

(30) Foreign Application Priority Data
Feb. 5, 2015 (TW) 104201902

(51) Int. Cl. H01F 27/32; H01F 27/28; H01F 27/24

(52) U.S. Cl. CPC H01F 27/325; H01F 27/24; H01F 27/2823

(57) ABSTRACT

A transformer includes a bobbin having a winding base and a first extending portion, a honeycomb winding wound on the winding base, a first spiral winding coil disposed on the first extending portion, a first lateral plate disposed between the first spiral winding coil and the bobbin, and a magnetic core assembly including two magnetic cores. The first lateral plate has a first ring-shaped protruding portion sleeved on the first extending portion. A channel is defined by the first ring-shaped protruding portion and the first extending portion. Each magnetic core has a first lateral post and a second lateral post. The first lateral posts are disposed opposite to each other. The second lateral posts are disposed opposite to each other. Each of the first lateral posts is penetrated through the channel. By the air insulation and isolation, the heat dissipation and safety are enhanced, and the automatic manufacture is implemented.

### TECHNICAL FIELD

The present disclosure relates to a transformer, and more particularly to a high-voltage transformer utilizing a honeycomb winding so as to be automatically manufactured.

### BACKGROUND OF THE DISCLOSURE

A transformer plays a very important role in lots types of electric devices or electric apparatuses. That is, the transformer is considered as a necessary and critical component. With growing of the applications of the high-voltage apparatuses, a high-voltage transformer is going to be the most popular product.

Please refer to FIG. 1. FIG. 1 schematically illustrates the structure of a conventional transformer of prior art. As shown in FIG. 1, a magnetic core assembly 10 of a conventional transformer 1 is penetrated through a left bobbin 11 and a right bobbin 12. A primary winding 13 is wound on the right bobbin 12, and a secondary winding 14 is wound on the primary winding 13. In this conventional transformer 1, since the secondary winding 14 is wound on the primary winding 13, it is not simple for the secondary winding 14 to be arranged due to the intervals of the primary winding 13. In addition, a tape has to be wrapped around the primary winding 13 for meeting the safety requirements between the primary winding 13 and the secondary winding 14, such that the heat dissipation of the primary winding 13 is reduced. Moreover, if the tape or the winding is damaged, there still exists a risk of safety in this kind of winding manner and structure.

Please refer to FIG. 2. FIG. 2 schematically illustrates the structure of another conventional transformer of prior art. As shown in FIG. 2, a magnetic core assembly 20 of a conventional transformer 2 is penetrated through a left bobbin 21 and a right bobbin 22. A primary winding 23 is respectively wound on the left bobbin 21 and the right bobbin 22, and a secondary winding 24 is wound on the right bobbin 22. In this conventional transformer 2, since the secondary winding 24 and the primary winding 23 are directly wound on the right bobbin 22 but not wound on one of any winding, the arrangement issue caused by the intervals of winding is avoided, and the heat dissipation is enhanced. However, a larger leakage inductance is produced in this kind of conventional transformer 2, thereby reducing the product performance. Since a two-time winding action is necessary to wind the primary winding 23 on the left bobbin 21 and the right bobbin 22, the manufacturing process is complicated and difficult.

There is a need of providing a transformer to obviate the drawbacks encountered from the prior art.

### SUMMARY OF THE DISCLOSURE

It is an object of the present disclosure to provide a transformer in order to overcome the above-mentioned drawbacks encountered by the prior arts.

The present disclosure provides a transformer. By utilizing the honeycomb winding and the spiral winding coils as windings and utilizing the air as main insulation and isolation, the transformer achieves the advantages of being applied to be automatically wound and assembled, and enhancing the heat dissipation and safety.

The present disclosure also provides a transformer. Via the latches mechanism, the distances between the honeycomb winding and the spiral winding coils can be easily kept, so that the product properties can be ensured. Meanwhile, since the structure of the transformer is formed in manner of sandwich winding, the leakage inductance is effectively reduced and the distances between the honeycomb winding and the spiral winding coils are easy to be adjusted for designing the withstand voltage characteristics of the transformer.

In accordance with an aspect of the present disclosure, there is provided a transformer. The transformer includes a bobbin, a honeycomb winding, a first spiral winding coil, a first lateral plate and a magnetic core assembly. The bobbin has a winding base and a first extending portion extended from the winding base. The honeycomb winding is wound on the winding base. The first spiral winding coil is disposed on the first extending portion. The first lateral plate is disposed between the first spiral winding coil and the bobbin. The first lateral plate has a first ring-shaped protruding portion sleeved on the first extending portion. A channel is defined by the first ring-shaped protruding portion and the first extending portion. The magnetic core assembly includes two magnetic cores. Each magnetic core has a first lateral post and a second lateral post. The first lateral posts of the two magnetic cores are disposed opposite to each other. The second lateral posts of the two magnetic cores are disposed opposite to each other. Each of the first lateral posts is penetrated through the channel.

In accordance with another aspect of the present disclosure, there is provided a transformer. The transformer includes a bobbin, a honeycomb winding, a first spiral winding coil, a second spiral winding coil and a magnetic core assembly. The bobbin has a winding base, a first extending portion and a second extending portion. The first extending portion and the second extending portion are relatively extended from two sides of the winding base. A channel is defined by the first extending portion and the second extending portion. The honeycomb winding is wound on the winding base. The first spiral winding coil is disposed on the first extending portion. The second spiral winding coil is disposed on the second extending portion. The magnetic core assembly includes two magnetic cores. Each magnetic core has a first lateral post and a second lateral post. The first lateral posts of the two magnetic cores are disposed opposite to each other. The second lateral posts of the two magnetic cores are disposed opposite to each other. Each of the first lateral posts is penetrated through the channel.

The above contents of the present disclosure will become more readily apparent to those ordinarily skilled in the art after reviewing the following detailed description and accompanying drawings, in which:

### BRIEF DESCRIPTION OF THE DRAWINGS

FIG. 1 schematically illustrates the structure of a conventional transformer of prior art;

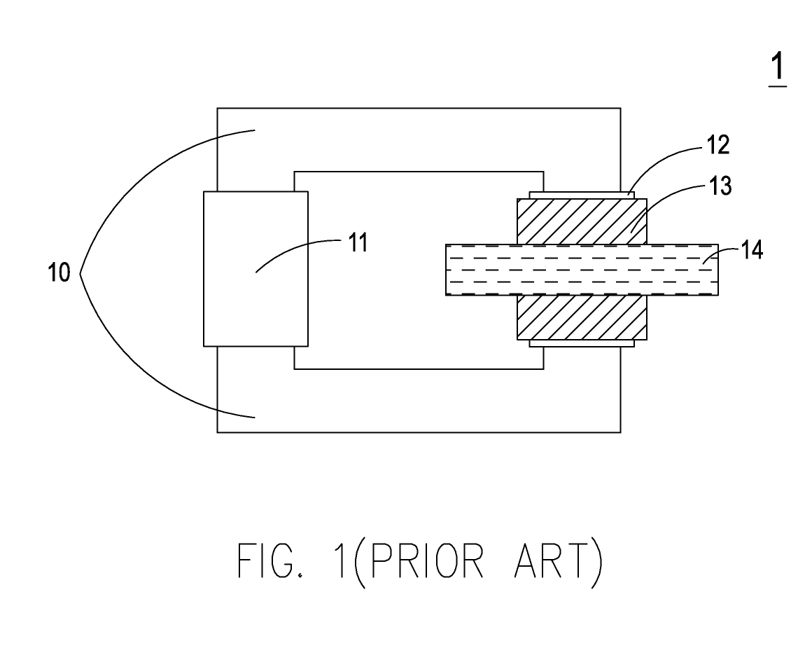

FIG. 2 schematically illustrates the structure of another conventional transformer of prior art;

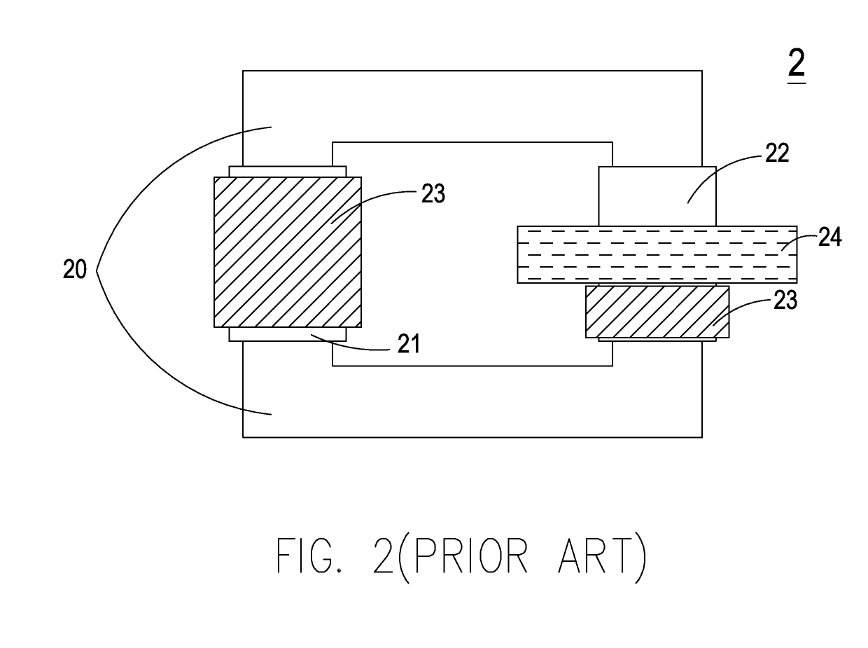

FIG. 3 schematically illustrates the exploded view of a transformer according to an embodiment of the present disclosure;

FIG. 4 schematically illustrates the combined structure of the transformer shown in FIG. 3;

FIG. 5 schematically illustrates the distance between the honeycomb winding and the first spiral winding coil and the distance between the honeycomb winding and the second spiral winding coil according to an embodiment of the present disclosure; and

FIG. 6 schematically illustrates the exploded view of a transformer according to another embodiment of the present disclosure.

### DETAILED DESCRIPTION OF THE PREFERRED EMBODIMENT

The present disclosure will now be described more specifically with reference to the following embodiments. It is to be noted that the following descriptions of preferred embodiments of this disclosure are presented herein for purpose of illustration and description only. It is not intended to be exhaustive or to be limited to the precise form disclosed.

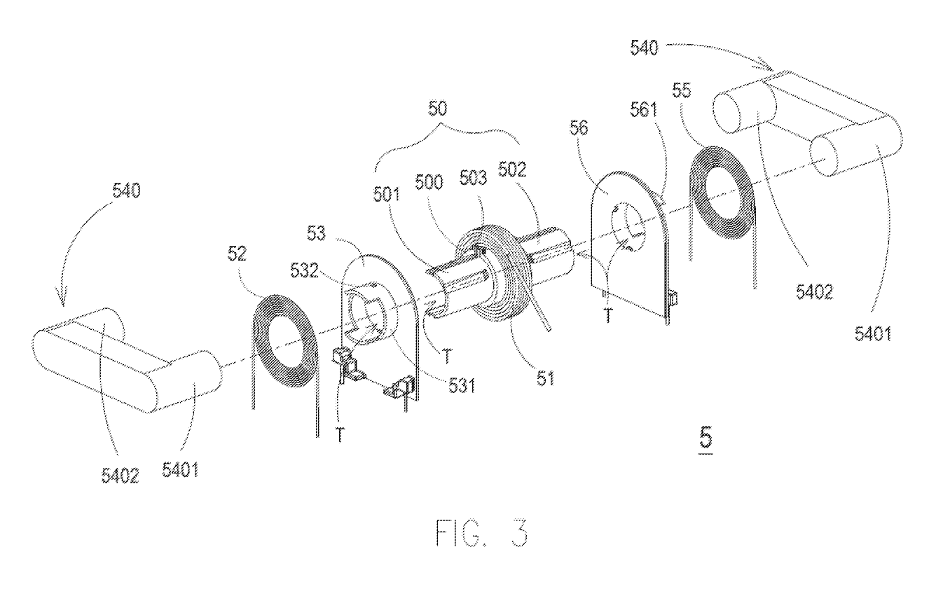

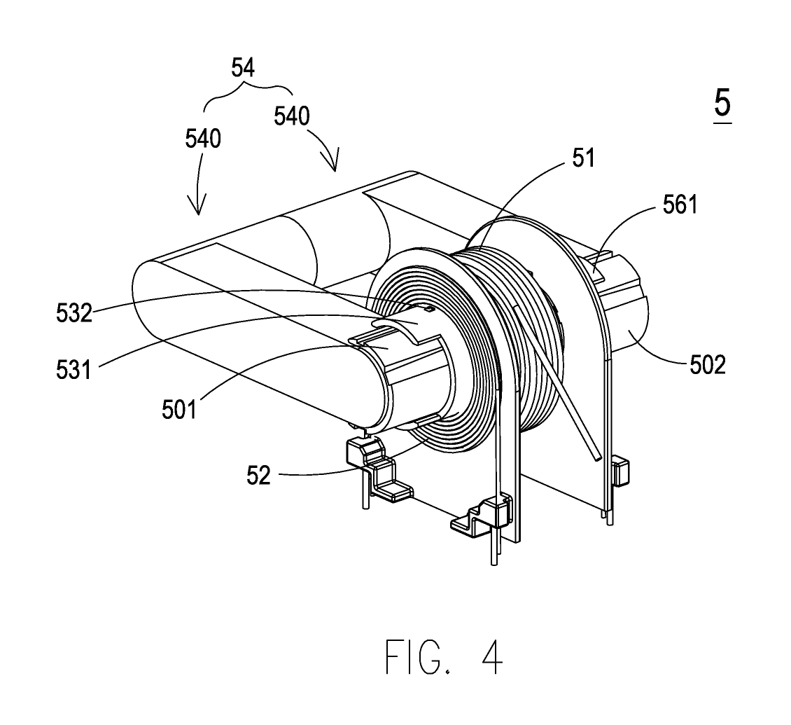

Please refer to FIG. 3 and FIG. 4. FIG. 3 schematically illustrates the exploded view of a transformer according to an embodiment of the present disclosure. FIG. 4 schematically illustrates the combined structure of the transformer shown in FIG. 3. As shown in FIG. 3 and FIG. 4, a transformer 5 of the present disclosure at least includes a bobbin 50, a honeycomb winding 51, a first spiral winding coil 52, a first lateral plate 53 and a magnetic core assembly 54. The bobbin 50 has a winding base 500 and a first extending portion 501. The honeycomb winding 51 is wound on the winding base 500. The first spiral winding coil 52 is disposed on the first extending portion 501. The first lateral plate 53 is disposed between the first spiral winding coil 52 and the bobbin 50. The first lateral plate 53 has a first ring-shaped protruding portion 531 sleeved on the first extending portion 501. A channel T is defined by the first ring-shaped protruding portion 531 and the first extending portion 501. The magnetic core assembly 54 includes two magnetic cores 540. The two magnetic cores 540 have similar exteriors and structures. Each magnetic core 540 has a first lateral post 5401 and a second lateral post 5402. The first lateral posts 5401 of the two magnetic cores 540 are disposed opposite to each other, the second lateral posts 5402 of the two magnetic cores 540 are disposed opposite to each other, and each of the first lateral posts 5401 is penetrated through the channel T, so that the transformer 5 is structured. In this embodiment, the magnetic core assembly 54 is a U-U core assembly, but not limited herein. Under this circumstance, the air is utilized as the main insulation and isolation between the honeycomb winding and the first spiral winding coil, and further the first lateral plate is utilized for increasing the creepage distance, so that the safety distance is increased, the heat dissipation is enhanced, and the safety is significantly enhanced.

In some embodiments, the bobbin 50 further has a second extending portion 502, and the second extending portion 502 and the first extending portion 501 are relatively extended from the two sides of the winding base 500. In addition, the transformer 5 further includes a second spiral winding coil 55. The second spiral winding coil 55 is disposed on the second extending portion 502. Certainly, the transformer 5 may also include a second lateral plate 56. The second lateral plate 56 is disposed between the second spiral winding coil 55 and the bobbin 50. The second lateral plate 56 has a second ring-shaped protruding portion 561 sleeved on the second extending portion 502. The channel T is defined by the second ring-shaped protruding portion 561, the second extending portion 502, the first ring-shaped protruding portion 531 and the first extending portion 501. Under this circumstance, the first spiral winding coil 52 is substantially sleeved on the first ring-shaped protruding portion 531, and the second spiral winding coil 55 is substantially sleeved on the second ring-shaped protruding portion 561.

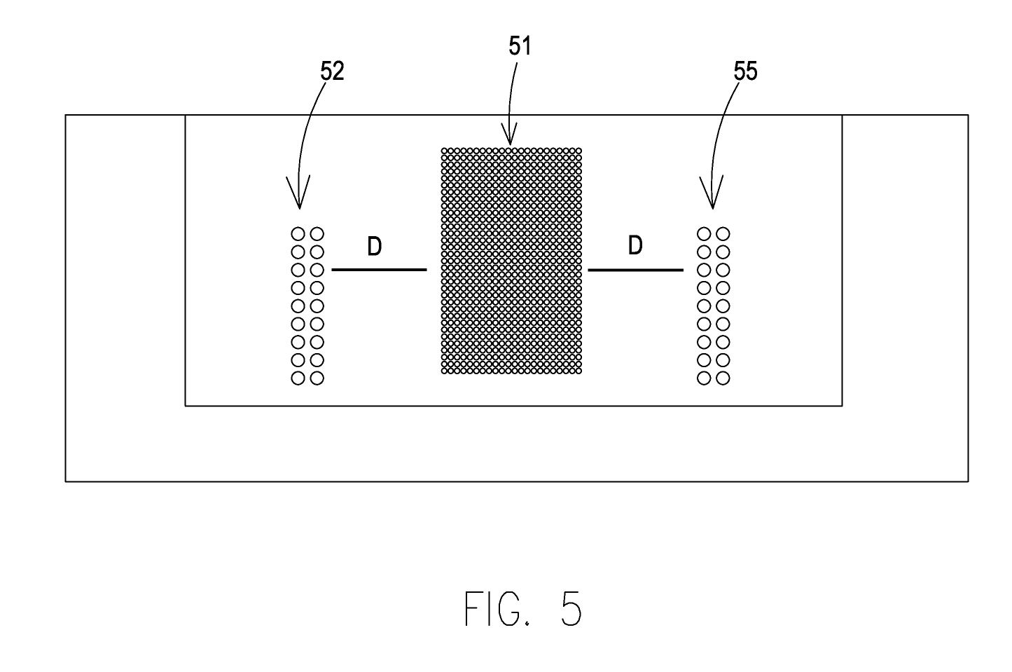

Please refer to FIG. 5. FIG. 5 schematically illustrates the distance between the honeycomb winding and the first spiral winding coil and the distance between the honeycomb winding and the second spiral winding coil according to an embodiment of the present disclosure. As shown in FIG. 5, interval distances D are between the honeycomb winding 51 and the first spiral winding coil 52 and between the honeycomb winding 51 and the second spiral winding coil 55. The interval distances D may be adjusted for meeting the practical demands of transformer design. For example, when the interval distances D are reduced, the leakage inductance of the transformer 5 is also reduced. In some embodiments, the honeycomb winding 51 is the secondary winding, and the first spiral winding coil 52 and the second spiral winding coil 55 are the primary winding, but not limited thereto. As a result, since the structure of the transformer in this embodiment is formed in manner of sandwich winding, the leakage inductance is effectively reduced and the distances between the honeycomb winding and the spiral winding coils are simply adjusted for designing the withstand voltage characteristics of the transformer.

Please refer to FIG. 3 and FIG. 4 again. In some embodiments, the first ring-shaped protruding portion 531 of the first lateral plate 53 and the second ring-shaped protruding portion 561 of the second lateral plate 56 of the transformer 5 of the present disclosure have at least a first latch 532 and at least a second latch for auxiliary positioning the first spiral winding coil 52 and the second spiral winding coil 55, respectively. It should be noted that since the first lateral plate 53 and the second lateral plate 56 have the similar exteriors and structures, the second latch is omitted on the drawings. However, the second latch can be indisputably deduced through referring to the first latch 532. Furthermore, the bobbin 50 of the transformer 5 further includes at least a base latch 503. The base latch 503 is disposed on the edge of the winding base 500 for auxiliary positioning the honeycomb winding 51. In brief, via the latches mechanism, the distances between the honeycomb winding and the spiral winding coils can be easily kept, so that the product properties can be ensured. The transformer 5 is applied to be automatically wound and assembled, thereby implementing the automatic manufacture.

In some embodiments, the diameter of the wire of the honeycomb winding 51 is preferably 0.23 millimeters, and the amount of the turns of the honeycomb winding 51 is at least 2000. Since the honeycomb winding 51 can be easily wound as pillar-shaped, the volume is significantly reduced. As a result, the transformer 5 of the present disclosure can be applied to high withstand voltage (e.g. more than 7500 volts). Compared with the withstand voltage between 2000 volts and 5000 volts of the conventional transformer, the withstand voltage characteristics of the transformer 5 of the present disclosure is significantly enhanced.

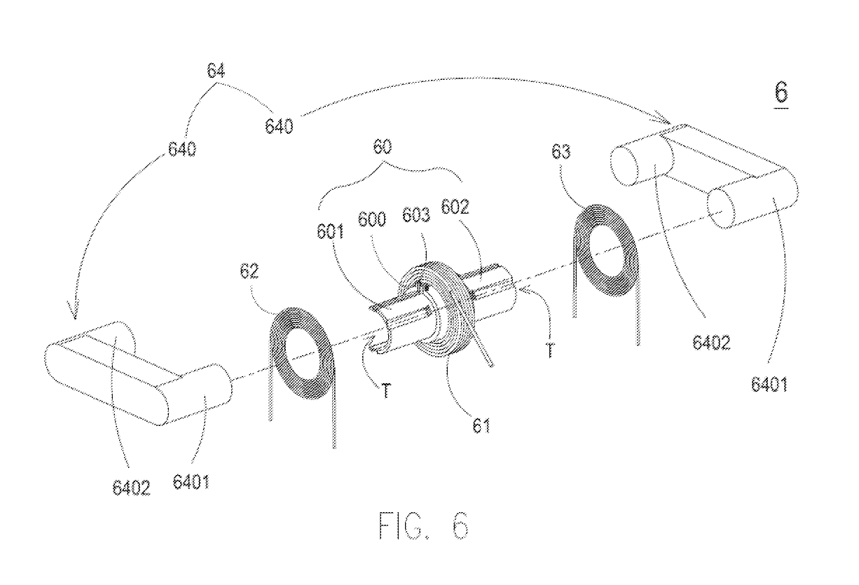

Please refer to FIG. 6. FIG. 6 schematically illustrates the exploded view of a transformer according to another embodiment of the present disclosure. As shown in FIG. 6, there is also provided a transformer 6. The transformer 6 includes a bobbin 60, a honeycomb winding 61, a first spiral winding coil 62, a second spiral winding coil 63 and a magnetic core assembly 64. The bobbin 60 has a winding base 600, a first extending portion 601 and a second extending portion 602. The first extending portion 601 and the second extending portion 602 are relatively extended from the two sides of the winding base 600. A channel T is defined by the first extending portion 601 and the second extending portion 602. The honeycomb winding 61 is wound on the winding base 600. The first spiral winding coil 62 is disposed on the first extending portion 601. The second spiral winding coil 63 is disposed on the second extending portion 602. The magnetic core assembly 64 includes two magnetic cores 640. Each magnetic core 640 has a first lateral post 6401 and a second lateral post 6402. The first lateral posts 6401 of the two magnetic cores 640 are disposed opposite to each other. The second lateral posts 6402 of the two magnetic cores 640 are disposed opposite to each other. Each of the first lateral posts 6401 is penetrated through the channel T. Compared with the transformer 5 of the embodiment mentioned above, the transformer 6 of this embodiment is a transformer with a plate-less bobbin, so that the transformer of the present disclosure are applied to the products met different demands.

From the above description, the present disclosure provides a transformer. By utilizing the honeycomb winding and the spiral winding coils, and by utilizing the air as main insulation and isolation, the transformer achieves the advantages of being applied to be automatically wound and assembled, and enhancing the heat dissipation and safety. On the other hand, via the latches mechanism, the distances between the honeycomb winding and the spiral winding coils can be easily kept, so that the product properties can be ensured. Meanwhile, since the structure of the transformer is formed in manner of sandwich winding, the leakage inductance is effectively reduced and the distances between the honeycomb winding and the spiral winding coils are easy to be adjusted for designing the withstand voltage characteristics of the transformer.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A transformer, comprising:
a bobbin having a winding base and a first extending portion extended from the winding base;
a honeycomb winding wound on the winding base;
a first spiral winding coil disposed on the first extending portion;
a first lateral plate disposed between the first spiral winding coil and the bobbin, wherein the first lateral plate has a first ring-shaped protruding portion sleeved on the first extending portion, and a channel is defined by the first ring-shaped protruding portion and the first extending portion; and
a magnetic core assembly comprising two magnetic cores, wherein each magnetic core has a first lateral post and a second lateral post, the first lateral posts of the two magnetic cores are disposed opposite to each other, the second lateral posts of the two magnetic cores are disposed opposite to each other, and each of the first lateral posts is penetrated through the channel.

2. The transformer according to claim 1, wherein the bobbin further has a second extending portion, and the second extending portion and the first extending portion are relatively extended from two sides of the winding base.

3. The transformer according to claim 2 further comprising a second spiral winding coil disposed on the second extending portion.

4. The transformer according to claim 3 further comprising a second lateral plate disposed between the second spiral winding coil and the bobbin, wherein the second lateral plate has a second ring-shaped protruding portion sleeved on the second extending portion, and the channel is defined by the second ring-shaped protruding portion, the second extending portion, the first ring-shaped protruding portion and the first extending portion.

5. The transformer according to claim 4, wherein the first spiral winding coil is sleeved on the first ring-shaped protruding portion, and the second spiral winding coil is sleeved on the second ring-shaped protruding portion.

6. The transformer according to claim 5, wherein the first ring-shaped protruding portion and the second ring-shaped protruding portion have at least a first latch and at least a second latch for auxiliary positioning the first spiral winding coil and the second spiral winding coil, respectively.

7. The transformer according to claim 3, wherein the honeycomb winding is used for secondary winding, and the first spiral winding coil and the second spiral winding coil are used for primary winding.

8. The transformer according to claim 1, wherein the bobbin further comprises at least a base latch disposed on an edge of the winding base for auxiliary positioning the honeycomb winding.

9. The transformer according to claim 1, wherein the diameter of the wire of the honeycomb winding is 0.23 millimeters, and the amount of the turns of the honeycomb winding is at least 2000.

10. A transformer, comprising:
a bobbin having a winding base, a first extending portion and a second extending portion, wherein the first extending portion and the second extending portion are relatively extended from two sides of the winding base, and a channel is defined by the first extending portion and the second extending portion;
a honeycomb winding wound on the winding base;
a first spiral winding coil disposed on the first extending portion;
a second spiral winding coil disposed on the second extending portion; and
a magnetic core assembly comprising two magnetic cores, wherein each magnetic core has a first lateral post and a second lateral post, the first lateral posts of the two magnetic cores are disposed opposite to each other, the second lateral posts of the two magnetic cores are disposed opposite to each other, and each of the first lateral posts is penetrated through the channel.
